(19) United States
(12) Patent Application Publication
(10) Pub. No.: US 2025/0214555 A1
(43) Pub. Date: Jul. 3, 2025

(54) HYDRAULIC SUPPLY

(71) Applicant: HL Mando Corporation, Pyeongtaek (KR)

(72) Inventor: Seongmoo HEO, Pyeongtaek (KR)

(21) Appl. No.: 18/639,996

(22) Filed: Apr. 19, 2024

(30) Foreign Application Priority Data
Jan. 3, 2024 (KR) 10-2024-0001184

(51) Int. Cl. B60T 13/74; B60T 13/16

(52) U.S. Cl. CPC B60T 13/745; B60T 13/168

(57) ABSTRACT

A hydraulic supply includes a motor coupled to a modulator block and having a stator and a rotor, a rotation shaft coupled to the rotor to rotate with the rotor, and a sensor assembly coupled to the rotation shaft to measure rotation frequency of the rotation shaft, wherein the sensor assembly rotates with the rotation shaft in response to a change in the angle between the rotation shaft and the rotor.

### CROSS-REFERENCE TO RELATED APPLICATION

This application claims priority from Korean Patent Application No. 10-2024-0001184, filed on Jan. 3, 2024, which is hereby incorporated by reference for all purposes as if fully set forth herein.

### BACKGROUND

### Field

Embodiments of the disclosure relate to a hydraulic supply that facilitates maintaining a gap between a magnet and a motor position sensor.

### Description of Related Art

In general, vehicles are essentially equipped with brake systems for braking, and in recent years, various types of electronic brake systems have been proposed to obtain stronger and more stable braking power, such as an integrated dynamic brake (IDB) system in which an electronic booster and an electronic controller are integrated.

Such IDB systems include a hydraulic supply that outputs an electrical signal indicative of the operation of a brake pedal by means of a pedal displacement sensor to activate a motor, and converts the rotational force of the motor into a linear motion to generate a braking hydraulic pressure. Additionally, a modulator block having a plurality of valves is installed to receive the hydraulic pressure with the force generated by the hydraulic supply to control the braking operation. The IDB systems also include an electronic controller that controls the motor and the valves.

Meanwhile, the IDB system further includes a motor position sensor (MPS) for measuring the operational state of the motor so as to determine the advancement distance of a piston obtained from RPM generated by the motor.

At this time, a magnet is installed to transmit the rotation information of the motor to the electronic controller. It is crucial to maintain a gap between the magnet and the motor position sensor.

Therefore, the IDB brake system is required to be designed to maintain the gap between the magnet and the motor position sensor so that the detection performance of the motor position sensor is improved.

### BRIEF SUMMARY

Embodiments of the present disclosure are directed to a hydraulic supply in which in response to a change in the angle between a sensor assembly and a rotation shaft, the sensor assembly stably rotates within a certain angle so that a gap between a magnet and a motor position sensor is kept constant, thereby effectively determining the operational state of a motor and thus improving the detection performance of the motor position sensor.

In an aspect of the present disclosure, a hydraulic supply includes: a motor having a stator and a rotor and coupled to a modulator block having a flow path and a valve provided therein to regulate a braking hydraulic pressure; a rotation shaft coupled to the rotor to rotate along with the rotor; a ball nut to which a piston is coupled and which is coaxially connected to the rotation shaft in a ball screw coupling manner to convert a rotational motion of the rotation shaft into a linear motion; and a sensor assembly coupled to the rotation shaft to measure rotation frequency of the rotation shaft, wherein the sensor assembly rotates with the rotation shaft within a certain angle in response to a change in the angle with the rotation shaft.

In another aspect of the present disclosure, a hydraulic supply includes: a motor having a stator and a rotor and coupled to a modulator block having a flow path and a valve provided therein to regulate a braking hydraulic pressure; a rotation shaft coupled to the rotor to rotate along with the rotor; a ball nut to which a piston is coupled and which is coaxially connected to the rotation shaft in a ball screw coupling manner to convert a rotational motion of the rotation shaft into a linear motion; a sensor assembly coupled to the rotation shaft to measure RPM of the rotation shaft; and a tolerance ring interposed between the rotation shaft and the sensor assembly to transmit a rotational force of the rotation shaft to the sensor assembly such that the sensor assembly rotates with the rotation shaft within a certain angle in response to a change in the angle between the sensor assembly and the rotation shaft.

In accordance with the present embodiments, the hydraulic supply enables the sensor assembly to stably rotate within a certain angle in response to a change in the angle between the sensor assembly and the rotation shaft so that the gap between the magnet and the motor position sensor may be kept constant, thereby effectively determining the operational state of the motor and improving the detection performance of the motor position sensor.

### DESCRIPTION OF DRAWINGS

The above and other objects, features, and advantages of the present disclosure will be more clearly understood from the following detailed description, taken in conjunction with the accompanying drawings, in which:

FIG. 1 is a schematic view illustrating an electronic brake system including an actuator according to an embodiment;

FIG. 2 is a cross-sectional view illustrating a hydraulic supply according to an embodiment;

FIG. 3 is a perspective view illustrating a portion of the hydraulic supply according to an embodiment;

FIG. 4 is an exploded perspective view illustrating a portion of the hydraulic supply according to an embodiment;

FIG. 5 is a side view illustrating a portion of the hydraulic supply according to an embodiment;

FIG. 6 is a perspective view illustrating a portion of a hydraulic supply according to another embodiment;

FIG. 7 is an exploded perspective view illustrating a portion of the hydraulic supply according to another embodiment;

FIG. 8 is a perspective view illustrating a portion of a hydraulic supply according to a still another embodiment;

FIG. 9 is an exploded perspective view illustrating a portion of the hydraulic supply according to a still another embodiment;

FIG. 10 is a perspective view illustrating a portion of the hydraulic supply according to a still another embodiment; and

FIG. 11 is an exploded perspective view illustrating a portion of the hydraulic supply according to a still another embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe that one is performed before or after the other. However, they may be non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

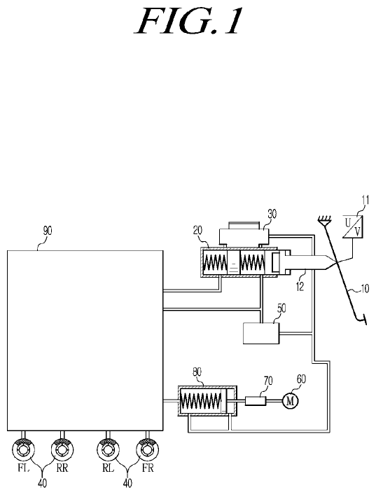

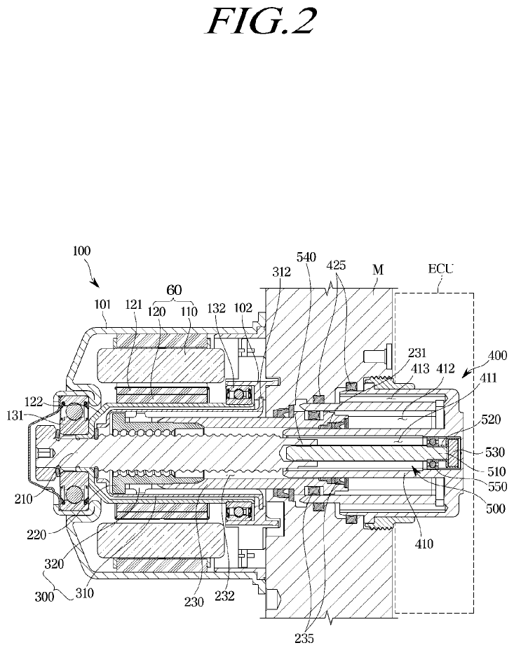

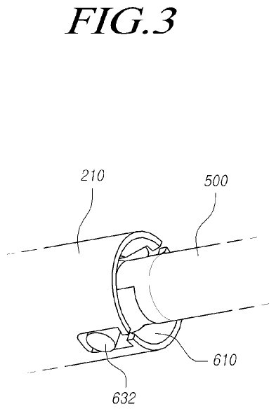

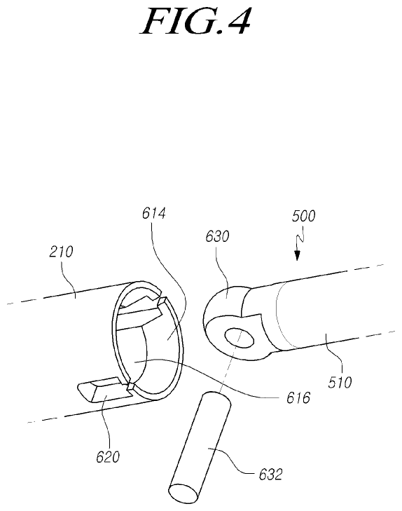

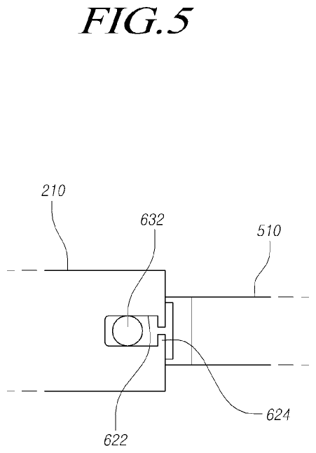

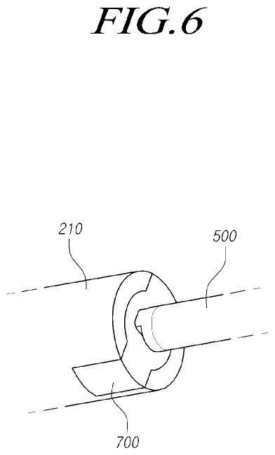

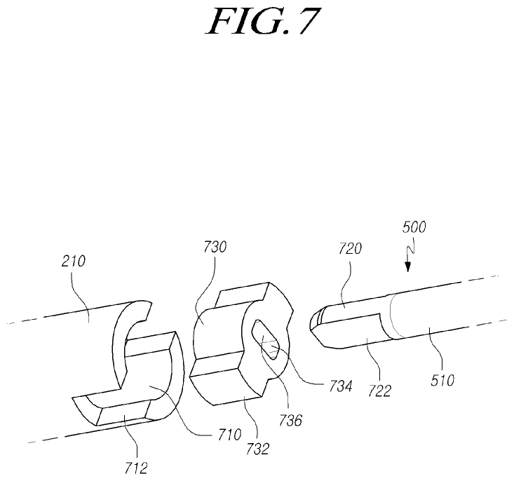

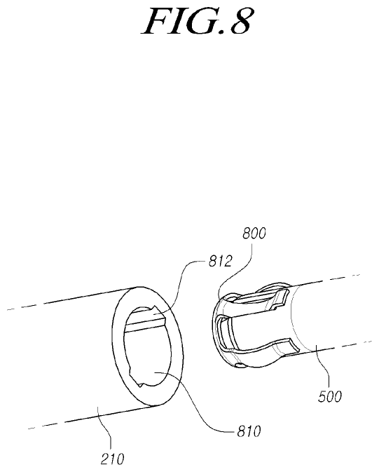

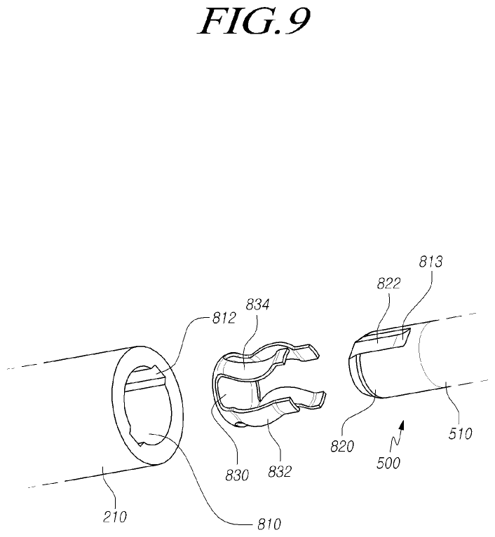

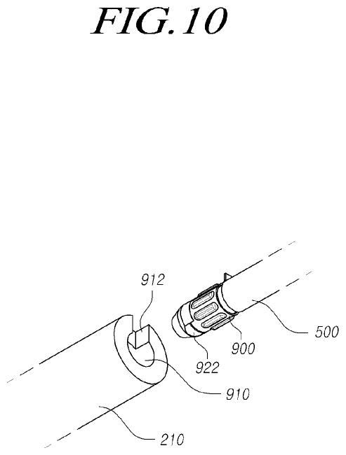

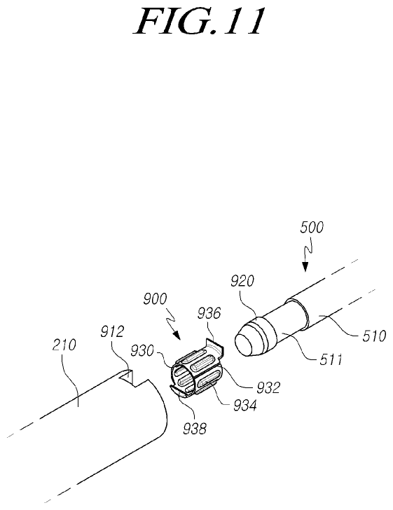

FIG. 1 is a schematic view illustrating an electronic brake system including an actuator according to an embodiment; FIG. 2 is a cross-sectional view illustrating a hydraulic supply according to an embodiment; FIG. 3 is a perspective view illustrating a portion of the hydraulic supply according to an embodiment; FIG. 4 is an exploded perspective view illustrating a portion of the hydraulic supply according to an embodiment; FIG. 5 is a side view illustrating a portion of the hydraulic supply according to an embodiment; FIG. 6 is a perspective view illustrating a portion of a hydraulic supply according to another embodiment; FIG. 7 is an exploded perspective view illustrating a portion of the hydraulic supply according to another embodiment; FIG. 8 is a perspective view illustrating a portion of a hydraulic supply according to a still another embodiment; FIG. 9 is an exploded perspective view illustrating a portion of the hydraulic supply according to a still another embodiment; FIG. 10 is a perspective view illustrating a portion of the hydraulic supply according to a still another embodiment; and FIG. 11 is an exploded perspective view illustrating a portion of the hydraulic supply according to a still another embodiment.

Prior to describing an actuator according to an embodiment, an electronic brake system will be briefly described with reference to FIG. 1.

FIG. 1 is a schematic view illustrating an electronic brake system including an actuator according to an embodiment.

As illustrated in FIG. 1, the electronic brake system for a vehicle may include a master cylinder 20, a reservoir 30, a wheel cylinder 40, a pedal simulator 50, a motor 60, a power transmission 70, a pump 80, and a hydraulic circuit 90 for controlling the above elements.

The master cylinder 20 serves to generate a hydraulic pressure by being pressurized by an input rod 12 when the driver operates a brake pedal 10, and the generated hydraulic pressure is transferred to the pedal simulator 50.

The pedal simulator 50 transmits a reaction force corresponding to the generated hydraulic pressure back to the brake pedal 10 via the master cylinder 20 so that the driver is able to feel the reaction force of the pedal pressure.

In a normal braking condition, the pump 80 delivers fluid to the wheel cylinder 40.

However, in the event of an abnormal braking condition, the hydraulic pressure from the master cylinder 20 is directed directly toward the wheel cylinder 40 to cause emergency braking of the vehicle.

Specifically, when the driver presses the brake pedal 10, a displacement sensor 11 detects the displacement of the brake pedal 10 and transmits the detected displacement to the electronic controller (ECU), which in turn drives the motor 60 based on the detected displacement of the brake pedal 10.

The rotational motion generated by the motor 60 is converted into a linear reciprocating motion by the power transmission 70 to pressurize a piston in the pump 80, which moves the fluid contained in a chamber of the pump 80 toward the wheel cylinder 40 to generate a braking force.

The reservoir 30 is a means for storing fluid and is arranged to be in communication with the master cylinder 20, the wheel cylinder 40, the pedal simulator 50, and the pump 80.

The hydraulic circuit 90 includes a plurality of flow paths for transferring the fluid between the master cylinder 20, the pump 80, and the wheel cylinder 40. The hydraulic circuit 90 also includes a plurality of valves for regulating a flow of fluid in the flow paths. The arrangements of respective components and the operation of controlling the components with the electronic controller are known in the art of vehicle braking, so a detailed description thereof will be omitted.

The hydraulic supply according to the present disclosure includes the motor 60, the power transmission unit 70, and the pump 80 described above.

FIG. 2 is a cross-sectional view illustrating a hydraulic supply according to an embodiment.

The hydraulic supply 100 according to the embodiment includes a motor 60 coupled to a modulator block M, a rotation shaft 210 coupled to a rotor 120 of the motor 60, a ball nut 220 coupled to a piston 230 and connected to the rotation shaft 210 in a ball screw coupling manner, an anti-rotation member 300 that prevents the rotation shaft 210 and the ball nut 220 from rotating together, and a sensor assembly 500 coupled to the rotation shaft 210.

The modulator block M is connected to the hydraulic supply 100 and the master cylinder 20, and is provided therein with flow paths and valves for regulating the braking hydraulic pressure.

In addition, the modulator block M is provided with an electronic controller (ECU), which controls the valves and the motor 60 of the hydraulic supply 100 to transmit the braking hydraulic pressure to the wheel cylinders provided on respective wheels.

The electronic controller (ECU) is provided with a sensing part (not shown) that detects a change in the magnetic field caused by a magnet 530 of the sensor assembly 500 to be described later.

A motor housing 101 and a pump housing 400 are coupled to both sides of the modulator block M, respectively.

A motor cover 102 is interposed between the motor 60 installed in the motor housing 101 and the modulator block M.

The motor housing 101 is coupled to one side of the modulator block M in a state of being combined with the motor cover 102.

The pump housing 400 is coupled to the other side of the modulator block M, forming a cylinder in which a piston 230 reciprocates (i.e., moves back and forth) in a straight line.

Here, in the space between the cylinder and the piston 230, a pump chamber 412 is formed in which the working fluid is introduced, and a pump sealing member 425 is provided between the outer surface of the pump housing 400 and the modulator block M to prevent an outflow of the working fluid.

The pump housing 400 is provided therein with a guide portion 410 in a cylindrical shape with one side opened to receive a shaft 510 of the sensor assembly 500 to be described later. At least a portion of the cylindrical shape of the guide portion 410 is disposed inside the cylinder formed by the pump housing 400, and they may be concentric (i.e., coaxial).

The cylinder formed by the pump housing 500 is divided by the guide portion 410 into a first space portion 411, which is an internal space of the guide portion 410, and a second space portion 412, which is a space between the guide portion 510 and the cylinder. The second space portion 412 accommodates the piston 230.

Furthermore, the pump housing 400 is formed with a flow path 413 that communicates with the second space portion 412.

That is, the working fluid accommodated in the second space portion 412, which is a pump chamber, flows in and out of the internal flow paths of the modulator block M through the flow path 413 in response to the operation of the piston 230.

The motor 60 is formed with a hollow motor having a stator 110 and a rotor 120 installed in the motor housing 101.

The rotor 120 has a cylindrical shape with a hollow center, and magnetic elements 121 are installed at predetermined intervals along the outer circumferential surface of the cylindrical shape.

The stator 110 is spaced apart a certain distance from the rotor 120 and is formed to surround the rotor 120.

A coil (not shown) is wound around the stator 110, so that when power is applied, an attractive force and a repulsive force are applied between the magnetic elements 121 and the coil to allow the rotor 120 to rotate.

A rotation shaft 210 having a predetermined length is centrally installed on the motor 60 so that the rotation shaft 210 rotates with the rotor 120.

As illustrated, the rotation shaft 210 is arranged to rotate with a rotation body 122 of the rotor 120.

The rotation body 122 is formed with a longitudinally extended hollow body with the rotation shaft 210 located therein.

One side of the rotation body 122 is arranged to have a reduced inner diameter and is coupled to the rotation shaft 210 so as to rotate with the rotation shaft 210.

The rotation body 122 is supported at both end sides thereof by a first bearing 131 and a second bearing 132, respectively, to stably rotate with the rotor 120.

The first bearing 131 is interposed between the motor housing 101 and the rotation body 122 to support one end side of the rotation body 122, and the second bearing 132 is interposed between the motor cover 102 and the rotation body 122 to support the other end side of the rotation body 122.

The rotation shaft 210 may be provided as a screw shaft that is press-fitted into the rotation body 122 to rotate with the rotation body 122.

A ball nut 220 is arranged to be coupled to the rotation shaft 210 in a ball screw coupling manner to convert a rotational motion into a linear reciprocating motion.

A plurality of balls fills a space between the rotation shaft 210 and the ball nut 220 to reduce energy due to friction.

At this time, an anti-rotation part 300 is provided between the motor cover 102 and the ball nut 220 so that the motion of the ball nut 220 is converted into a linear motion in response to the rotation of the rotation shaft 210.

The anti-rotation part 300 includes a sleeve 310 fastened to the motor cover 102 or the modulator block M to surround the ball nut 220, and a ring member 320 coupled to the sleeve 310 to prevent rotation.

The sleeve 310 is formed with a longitudinally hollow member so that the ball not 220 is located therein. The sleeve 310 has at least one slot formed on the inner surface along the longitudinal direction.

Further, the sleeve 310 is spaced apart a certain distance from the rotation body 122 to prevent interference with the rotor 120, and is bent on the other side to form a flange 312 that is fastened to the motor cover 102.

The ring member 320 is coupled to the ball nut 220 and has at least one restraining protrusion formed on the outer circumferential surface.

The restraining protrusion is inserted into the slot, formed on the inner surface of the sleeve 310, at a position corresponding to the slot, and moves along the slot during the movement of the ball nut 220 to prevent rotation of the ball nut 220.

On the other hand, the ball nut 220 is coupled to a piston 230 to reciprocate linearly with the piston 230.

The piston 230 has a hollow cylindrical shape with one end coupled to the ball nut 220 and the other end inserted into the cylinder of the pump housing 400.

A hollow portion 232 of the piston 230 receives the rotation shaft 210 and the guide portion 410 of the pump housing 400.

In this case, a guide bush 231 is provided between the inner surface of the piston 230 and the outer surface of the guide portion 410.

In addition, a sealing member 235 is provided between the outer surface of the piston 230 and the pump housing 400 and between the inner surface of the piston 230 and the guide portion 410 to prevent oil leakage during the operation of the piston 230.

The sensor assembly 500 is coupled to the rotation shaft 210 and serves to measure the rotation direction and rotation frequency of the rotation shaft 210 such as revolution per minute (i.e., RPM). The sensor assembly 500 includes the shaft 510, a holder 520, the magnet 530, a third bearing 550. The shaft 510 is coupled with and rotates together with the rotation shaft 210. The shaft 510 may be referred to as a sensor side shaft 510 to be distinguished from the rotation shaft 210.

One end of the holder 520 is fastened to the other end of the shaft 510, and at the other end of the holder 520, an accommodating space is provided so that the magnet 530 is installed therein.

Thus, if the shaft 510 rotates with the rotation shaft 210, the holder 520 and the magnet 530 rotate with the shaft 510.

On the other hand, the sensor assembly 500 further includes a third bearing 550 that rotatably supports the shaft 510.

The third bearing 550 is supported on the inner side of the guide portion 410 to diametrically support the shaft 510 so that the shaft 510 and the magnet 530 may rotate stably.

Such a sensor assembly 500 may include a sensing part (not shown) provided in the electronic controller (ECU).

The sensing part detects a change in the magnetic field caused by the rotation of the magnet 530 and measures the rotation direction and RPM of the rotation shaft 210.

In other words, based on the information sensed by the sensing part, the electronic controller (ECU) may determine the movement of the piston 230 and control the operation of the motor 60.

In an aspect, the present embodiments are directed to a hydraulic supply including: a motor 60 having a stator 110 and a rotor 120 and coupled to a modulator block M having a flow path and a valve provided therein to regulate a braking hydraulic pressure; a rotation shaft 210 coupled to the rotor 120 to rotate with the rotor 120; a ball nut 220 to which a piston 230 is coupled and which is coaxially connected to the rotation shaft 210 in a ball screw coupling manner to convert a rotational motion of the rotation shaft 210 into a linear motion; and a sensor assembly 500 coupled to the rotation shaft 210 to measure RPM of the rotation shaft 210, wherein the sensor assembly 500 rotates with the rotation shaft 210 within a certain angle in response to a change in the angle with the rotation shaft 210.

In an example, the rotation shaft 210 includes: a mounting groove 610 formed at an end opposite to an end to which the rotor 120 is coupled in an axial direction toward the sensor assembly 500; and a pair of axially elongated slots 620 formed through the rotation shaft at both diametrical sides from the inside of the mounting groove 610. The sensor assembly 500 includes: a shaft 510 coupled to the rotation shaft 210; a ball member 630 inserted into the mounting groove 610 and integrally formed at one end of the shaft 510; a pin member 632 engaged through the ball member 630 so that both sides are positioned in the slots 620; and a magnet 530 mounted at the other end of the shaft 510.

Throughout the specification, a direction in which the rotation body 122 longitudinally extends may be referred to a longitudinal direction or an axial direction. And, in the longitudinal or axial direction, a direction toward the one side of the rotation shaft 210 to which the rotor 120 is coupled may be referred to as one end side direction or a first axial side direction and a direction opposite to the one end side direction may be referred to as the other end side direction or a second axial side direction. Also, the end of the rotation shaft 210 to which the rotor 120 is coupled may be referred to a rotor coupling end, and the opposite end of the rotation shaft 210 in the axial (i.e., longitudinal) direction may be referred to as a sensor assembly coupling end. Also, a direction from a rotational axis of the rotation shaft 210 toward the outer surface of the rotation shaft 210 may be referred to a radial direction.

Here, the rotation shaft 210 includes the mounting groove 610 formed at the end opposite to the end to which the rotation body 122 is coupled in an axial direction toward the sensor assembly 500 (i.e., formed at a second axial side end). The rotation shaft 210 also includes the axially elongated slots 620 formed through the rotation shaft at both diametrical sides from the inside of the mounting groove 610.

The mounting groove 610 is formed axially extending toward the sensor assembly 500 at the end opposite to the end of the rotation shaft 210 to which the rotation body 122 is coupled (i.e., at the second axial side end).

The mounting groove 610 includes a tapered inclined portion 614 with a diameter decreasing from the outside toward inside of the mounting groove (i.e., diameter decreasing toward the first axial side direction) so that the ball member 630 is inserted therethrough, and an accommodation portion 616 formed continuously inwardly from the inclined portion 614 to have a straight structure to accommodate the ball member 630.

The inclined portion 614 is formed to have a diameter decreasing from the outside toward inside of the mounting groove so as to guide the ball member 630 and facilitate insertion of the ball member 630.

The accommodation portion 616 is formed to extend further inwardly from the inward end of the tapered inclined portion 614 and accommodate the ball member 630 inserted through the inclined portion 614. The accommodation portion 616 has a straight structure (i.e., a structure having a shape extending parallelly along the longitudinal direction).

The sensor assembly 500 includes a shaft 510 coaxially connected to the rotation shaft 210, a ball member 630 inserted into the mounting groove 610 and integrally formed at one end of the shaft 510, a pin member 632 engaged through the ball member 630 so that both sides are positioned in the slots 620; and a holder 520 fastened to the other end of the shaft 510 and a magnet 530 mounted on the holder 520.

The shaft 510 is coaxially connected to the rotation shaft 210 and is rotationally constrained to the rotation shaft 210 to rotate with the rotation shaft 210.

The ball member 630 is integrally formed at one end of the shaft 510 and is received via the inclined portion 614 and connected to an accommodation portion 616. The diameter of the ball member 630 may be larger than the diameter of the shaft 510. The ball member 630 has a hole penetrating the ball member in a direction perpendicular to the longitudinal direction. The ball member 630 may include a flat (i.e., planar) portion having two parallel surfaces, which are parallel to the axial direction (i.e., parallel to a central axis of the shaft 510). The width between the two parallel surfaces may be smaller than the diameter of the shaft 510.

The pin member 632 is coupled through the hole of the ball member 630 and protrudes bilaterally from the ball member 630 and fits into the slots 620 such that the shaft 510 rotates with the rotation shaft 210 within a certain angle in response to a change in the angle with rotation shaft 210.

The holder 520 is fastened to the other end of the shaft 510, and the magnet 530 is mounted on the holder 520 to rotate with the shaft 510.

Here, the slot 620 includes a guide portion 622 along which the pin member 632 is formed to be movable along the longitudinal direction, and an anti-dislodging portion 624 formed with a width smaller than the diameter of the pin member 632 to prevent the pin member 632 from dislodging.

The guide portion 622 is axially elongate and penetrates both longitudinally from the inner side of the mounting groove 610 to allow the pin member 632 to move along the longitudinal direction.

An anti-dislodging portion 624 is formed at the axially other end (i.e., the second axial side end) of the guide portion 622 with a width smaller than the diameter of the pin member 632 to prevent the pin member 632 from being dislodged.

Accordingly, according to the present embodiments, the sensor assembly 500 may be allowed to stably rotate within a certain angle even in the event of a change in the angle between the sensor assembly 500 and the rotation shaft 210, thereby maintaining a constant gap between the magnet 530 and the motor position sensor constant.

In another aspect, the present embodiments are directed to a hydraulic supply including: a motor 60 having a stator 110 and a rotor 120 and coupled to a modulator block M having a flow path and a valve provided therein to regulate a braking hydraulic pressure; a rotation shaft 210 coupled to the rotor 120 to rotate with the rotor 120; a ball nut 220 to which a piston 230 is coupled and which is coaxially connected to the rotation shaft 210 in a ball screw coupling manner to convert a rotational motion of the rotation shaft 210 into a linear motion; a sensor assembly 500 coupled to the rotation shaft 210 to measure RPM of the rotation shaft 210; and a tolerance ring 700 interposed between the rotation shaft 210 and the sensor assembly 500 to transmit a rotational force of the rotation shaft 210 to the sensor assembly 500 such that the sensor assembly 500 rotates with the rotation shaft 210 within a certain angle in response to a change in the angle between the sensor assembly 500 and the rotation shaft 210.

Here, the rotation shaft 210 includes a mounting groove 710 formed at an end opposite to an end to which the rotation body 122 is coupled in an axial direction toward the sensor assembly 500 (i.e., formed at the second axial side end).

The mounting groove 710 is formed in an axial direction toward the sensor assembly 500 at the end opposite to the end of the rotation shaft 210 to which the rotation body 122 is coupled (i.e., at the second axial side end).

Here, the mounting groove 710 includes an axially elongated engagement slot(s) 712 at one or both diametrical sides from the inside of the mounting groove. The axially elongated engagement slot(s) 712 may be formed through the rotation shaft 210 from the inside of the mounting groove 710.

The sensor assembly 500 includes a shaft 510 coupled to the rotation shaft 210, a rotational force transmission portion 720 which is integrally formed at one end of the shaft 510 and on which a tolerance ring 700 is mounted so that the rotational force transmission portion is inserted into the mounting groove 710 together with the tolerance ring 700, and a magnet 530 mounted at the other end of the shaft 510.

The shaft 510 is coaxially connected to the rotation shaft 210 and is rotationally constrained to the rotation shaft 210 by the tolerance ring 700 to rotate with the rotation shaft 210.

In this case, the rotational force transmission portion 720 is integrally formed at one end of the shaft 510, the holder 520 is fastened to the other end of the shaft 510, and the magnet 530 is mounted on the holder 520 to rotate with the shaft 510.

The rotational force transmission portion 720 is integrally formed at one end of the shaft 510 and is equipped with the tolerance ring 700 so that the rotational force transmission portion is inserted into the mounting groove 710 together with the tolerance ring 700.

Here, the rotational force transmission portion 720 includes at least one outer support surface 722 formed in a planar shape parallel with a center axis on an outer surface fitted into the tolerance ring 700.

One or more outer support surfaces 722 are formed in a planar shape parallel with the center axis on an outer surface of the rotational force transmission portion 720 fitted into the tolerance ring 700, and are supported on an inner support surface 736 of the tolerance ring 700 when the rotational force transmission portion 720 is fitted into the tolerance ring 700.

The tolerance ring 700 supports the outer support surface 722 of the rotational force transmission portion 720, and is inserted into the mounting groove 710 to transmit the rotational force of the rotation shaft 210 to the sensor assembly 500 while the tolerance ring is inserted into the mounting groove 710 and fitted into engagement slot 712.

Here, the tolerance ring 700 includes a support body 730 inserted into the mounting groove 710 and having an engagement hole 734 axially formed so that the rotational force transmission portion 720 is inserted therethrough and at least one inner support surface 736 formed on an inner surface of the engagement hole 734 in a plane shape parallel with the center axis in correspondence with the outer support surface 722, and one or more protrusions 732 formed on an outer surface of the support body 730 in correspondence with the engagement slot 712.

The support body 730 has an axial engagement hole 734 through which the rotational force transmission portion 720 is inserted, and at least one inner support surface 736 formed on an inner surface of the engagement hole 734 in a planar shape parallel with the center axis in correspondence with the outer support surface 722, wherein the rotational force transmission portion 720 is inserted into the mounting groove 710 and engagement slot 712 to transmit the rotational force of the rotation shaft 210 to the sensor assembly 500.

The tolerance ring 700 may be made of an elastic material having elasticity of returning to its original shape when deformed.

In an example, the tolerance ring 700 may be made of an elastic material such as rubber or urethane.

The tolerance ring 700 in this embodiment is interposed between the rotation shaft 210 and the sensor assembly 500, and is inserted into and engaged with the mounting groove 710 together with the rotational force transmission portion 720 to transmit the rotational force of the rotation shaft 210 to the sensor assembly 500.

Accordingly, this embodiment enables the sensor assembly 500 to stably rotate within a certain angle even in the event of a change in the angle between the sensor assembly 500 and the rotation shaft 210, thereby maintaining a constant gap between the magnet 530 and the motor position sensor.

In a still another aspect, the present embodiments are directed to a hydraulic supply including: a motor 60 having a stator 110 and a rotor 120 and coupled to a modulator block M having a flow path and a valve provided therein to regulate a braking hydraulic pressure; a rotation shaft 210 coupled to the rotor 120 to rotate with the rotor 120; a ball nut 220 to which a piston 230 is coupled and which is coaxially connected to the rotation shaft 210 in a ball screw coupling manner to convert a rotational motion of the rotation shaft 210 into a linear motion; a sensor assembly 500 coupled to the rotation shaft 210 to measure RPM of the rotation shaft 210; and a tolerance ring 800 interposed between the rotation shaft 210 and the sensor assembly 500 to transmit a rotational force of the rotation shaft 210 to the sensor assembly 500 such that the sensor assembly 500 rotates with the rotation shaft 210 within a certain angle in response to a change in the angle between the sensor assembly 500 and the rotation shaft 210.

Here, the rotation shaft 210 includes a mounting groove 810 formed at an end opposite to an end to which the rotation body 122 is coupled in an axial direction toward the sensor assembly 500 (i.e., formed at the second axial side end).

The mounting groove 810 is formed in an axial direction toward the sensor assembly 500 at the end opposite to the end of the rotation shaft 210 to which the rotation body 122 is coupled (i.e., at the second axial side end).

In this case, the mounting groove 810 includes one or more inner support recesses 812 formed extending axially and longitudinally on the inner surface.

The inner support recesses 812 are formed extending axially and longitudinally on the inner surface of the mounting groove 810, and are supported by a first support protrusion 832 of the tolerance ring 800 when the tolerance ring 800 is inserted into the mounting groove 810 together with the rotational force transmission portion 820.

In this embodiment, the inner support recesses 812 are formed on the inner surface of the mounting groove 810 symmetrically in a pair about a central axis of the mounting groove.

The sensor assembly 500 includes a shaft 510 coupled to the rotation shaft 210, a rotational force transmission portion 820 which is integrally formed at one end of the shaft 510 and on which the tolerance ring 800 is mounted so that the rotational force transmission portion is inserted into the mounting groove 810 together with the tolerance ring 800, and a magnet 530 mounted at the other end of the shaft 510.

The shaft 510 is coaxially connected to the rotation shaft 210 and is rotationally constrained to the rotation shaft 210 by the tolerance ring 800 to rotate with the rotation shaft 210.

In this case, the rotational force transmission portion 820 is integrally formed at one end of the shaft 510, the holder 520 is fastened to the other end of the shaft 510, and the magnet 530 is mounted on the holder 520 to rotate with the shaft 510.

The rotational force transmission portion 820 is integrally formed at one end of the shaft 510, and the tolerance ring 800 is mounted on the rotational force transmission portion so that the rotational force transmission portion is inserted into the mounting groove 810 together with the tolerance ring 800.

Here, the rotational force transmission portion 820 includes one or more outer support recesses 822 formed by extending longitudinally in the axial direction on the outer surface.

The outer support recesses 822 are formed axially and longitudinally on the outer surface of the rotational force transmission portion 820 on which the tolerance ring 800 is mounted. The outer support recesses 822 may be formed axially extending from the first axial side end of the rotational force transmission portion 820 toward the second axial side direction. The outer support recesses 822 may include an inner bottom surface in a flat shape parallel to the center axis of the shaft 510.

When the rotational force transmission portion 820 is inserted into the mounting groove with the tolerance ring 800 mounted thereon, second support protrusions 834 of the tolerance ring 800 are fitted into the outer support recesses 822.

Here, the outer support recess 822 may include a support surface 813 that is formed to be inclined from one side to the other for tolerance absorption such that the support surface is inclined in a direction away from the center axis on the side on which the second support protrusion 834 is supported toward the second axial side direction. Alternatively, the outer support recess 822 may be formed to be concavely curved from one side to the other (i.e., toward the second axial side direction) such that the support surface has a concave shape corresponding to the second support protrusion 834.

That is, for tolerance absorption, the outer support recess 822 may be inclined away from the center axis and in the direction in which the magnet 530 is mounted, continuous with the side on which the second support protrusion 834 is supported.

In addition, for tolerance absorption, the outer support recess may be curved away from the center axis in a continuous manner from the side on which the second support protrusion 834 is supported and in the direction in which the magnet 530 is mounted. In this embodiment, the outer support recesses 822 are formed on the outer surface of the rotational force transmission portion 820 symmetrically in a pair about the center axis of the rotational force transmission portion.

The tolerance ring 800 are fitted into the inner support recesses 812 and the outer support recesses 822 and transmits the rotational force of the rotation shaft 210 to the sensor assembly 500.

Here, the tolerance ring 800 includes a support portion 830 supported on one end side of the rotational force transmission portion 820 facing the rotation shaft 210, at least one first support protrusion 832 formed corresponding to the inner support recesses 812, axially extending from the support portion 830 in a diametrically convexly curved state so as to fit into the inner support recesses 812, and at least one second support protrusion 834 formed corresponding to the outer support recesses 822, axially extending from the support portion 830 in a diametrically concavely curved state so as to fit into the outer support recesses 822.

The support portion 830 is supported on one end side of the rotational force transmission portion 820 facing the rotation shaft 210 on one end side of the shaft 510. The support portion 830 may be convexly hemispherical, at least in part, in shape toward the rotation shaft 210 such that the sensor assembly 500 rotates with the rotation shaft 210 within a certain angle in response to a change in the angle between the sensor assembly 500 and the rotation shaft 210.

One or more first support protrusions 832 are formed corresponding to the inner support recesses 812 to fit into the inner support recesses 812, and elastically deform between the rotation shaft 210 and the sensor assembly 500 to transmit the rotational force of the rotation shaft 210 to the sensor assembly 500.

In this embodiment, the first support protrusions 832 are formed in a pair facing each other such that a portion of the periphery of the support portion 830 extends in the axial direction in a diametrically convexly curved state.

Here, the first support protrusion 832 may be convexly curved outwardly in the diametrical direction to fit into the inner support recess 812, or convexly bent outwardly in the diametrical direction to fit into the inner support recess 812.

One or more second support protrusions 834 are formed corresponding to the outer support recesses 822 to fit into the outer support recesses 822, and elastically deform between the rotation shaft 210 and the sensor assembly 500 to transmit the rotational force of the rotation shaft 210 to the sensor assembly 500.

In this embodiment, the second support protrusions 834 are formed in a pair facing each other such that a portion of the periphery of the support portion 830 extends in the axial direction in a diametrically concavely curved state.

Here, the second support protrusion 834 is concavely curved in the diametrical direction to fit into the outer support recess 822, or concavely bent in the diametrical direction to fit into the outer support recess 822.

The tolerance ring 800 may be made of spring steel to absorb and accumulate energy using elastic deformation between the rotation shaft 210 and the sensor assembly 500 to provide a cushioning effect.

The tolerance ring 800 in this embodiment is interposed between the rotation shaft 210 and the sensor assembly 500, and is inserted into and engaged with the mounting groove 810 together with the rotational force transmission portion 820 to transmit the rotational force of the rotation shaft 210 to the sensor assembly 500.

Accordingly, this embodiment enables the sensor assembly 500 to stably rotate within a certain angle even in the event of a change in the angle between the sensor assembly 500 and the rotation shaft 210, thereby maintaining a constant gap between the magnet 530 and the motor position sensor.

In a further aspect, the present embodiments are directed to a hydraulic supply including: a motor 60 having a stator 110 and a rotor 120 and coupled to a modulator block M having a flow path and a valve provided therein to regulate a braking hydraulic pressure; a rotation shaft 210 coupled to the rotor 120 to rotate with the rotor 120; a ball nut 220 to which a piston 230 is coupled and which is coaxially connected to the rotation shaft 210 in a ball screw coupling manner to convert a rotational motion of the rotation shaft 210 into a linear motion; a sensor assembly 500 coupled to the rotation shaft 210 to measure RPM of the rotation shaft 210; and a tolerance ring 900 interposed between the rotation shaft 210 and the sensor assembly 500 to transmit a rotational force of the rotation shaft 210 to the sensor assembly 500 such that the sensor assembly 500 rotates with the rotation shaft 210 within a certain angle in response to a change in the angle between the sensor assembly 500 and the rotation shaft 210.

Here, the rotation shaft 210 includes a mounting groove 910 formed at an end opposite to an end to which the rotation body 122 is coupled in an axial direction toward the sensor assembly 500 (i.e., formed at the second axial side end).

The mounting groove 910 is formed in an axial direction toward the sensor assembly 500 at the end opposite to the end of the rotation shaft 210 to which the rotation body 122 is coupled (i.e., at the second axial side end).

In this case, the mounting groove 910 includes one or more inner engagement slots 912 formed axially longitudinally elongated on the inner surface. The one or more inner engagement slots 912 may be formed through the rotation shaft 210 from the inside of the mounting groove 910.

The one or more inner engagement slot 912 is formed axially longitudinally elongated on the inner surface of the mounting groove 910, and are supported by an outer engagement protrusion 936 of the tolerance ring 900 when the tolerance ring 900 is inserted into the mounting groove 910 together with the rotational force transmission portion 920.

The sensor assembly 500 includes a shaft 510 coupled to the rotation shaft 210, a rotational force transmission portion 920 which is integrally formed at one end of the shaft 510 and on which the tolerance ring 900 is mounted so that the rotational force transmission portion is inserted into the mounting groove 910 together with the tolerance ring 900, and a magnet 530 mounted at the other end of the shaft 510.

The shaft 510 is coaxially connected to the rotation shaft 210 and is rotationally constrained to the rotation shaft 210 by the tolerance ring 900 to rotate with the rotation shaft 210.

In this case, the rotational force transmission portion 920 is integrally formed at one end of the shaft 510, the holder 520 is fastened to the other end of the shaft 510, and the magnet 530 is mounted on the holder 520 to rotate with the shaft 510.

The rotational force transmission portion 920 is integrally formed at one end of the shaft 510, and the tolerance ring 900 is mounted on the rotational force transmission portion so that the rotational force transmission portion is inserted into the mounting groove 910 together with the tolerance ring 900.

Here, the rotational force transmission portion 920 includes one or more outer engagement slots 922 formed longitudinally in the axial direction on the outer surface.

The outer engagement recesses 922 are formed axially longitudinally on the outer surface of the rotational force transmission portion 920 on which the tolerance ring 900 is mounted.

When the rotational force transmission portion 920 is inserted into the mounting groove with the tolerance ring 900 mounted thereon, inner engagement protrusions 938 of the tolerance ring 900 are fitted into the outer engagement recesses 922.

In addition, the rotational force transmission portion 920 includes a seating portion 511 formed on one side with a reduced diameter than the diameter of the other side such that a body portion 930 of the tolerance ring 900 is seated thereon.

The tolerance ring 900 is fitted into the inner engagement slots 912 and the outer engagement recesses 922 and transmits the rotational force of the rotation shaft 210 to the sensor assembly 500.

Here, the tolerance ring 900 includes a body portion 930 inserted into the mounting groove 910 while surrounding the rotational force transmission portion 920, at least one outer engagement protrusion 936 formed corresponding to the inner engagement slot 912, extending axially and diametrically outward from the body portion 930 to fit into the inner engagement slot 912, and at least one inner engagement protrusion 938 formed corresponding to the outer engagement recess 922, extending axially and diametrically inwardly from the body portion 930 to fit into the outer engagement recess 922.

The body portion 930 includes an incision 932 that is continuously formed along the entire length from one axial side to the other such that the diameter varies with elastic deformation.

That is, the incision 932 is formed by cutting a portion of the body portion 930 and is continuously formed from one axial side to the other along the entire length of the body portion 930. This incision 932 formed on the body portion 930 allows the diameter of the body portion 930 to be changed by deformation when the rotation force 920 is inserted into the tolerance ring and the body portion 930 is closely seated on the seating portion 511.

The body portion 930 also includes at least one resilient part 934 formed at regular circumferential intervals on the outer surface in a convex shape that is deformable by an external force.

The resilient part 934 is elongated in the axial direction and elastically deforms and cushions between the rotation shaft 210 and the sensor assembly 500.

The resilient part 934 may be formed using a stamping process that applies pressure to create a depression in the plane of the body portion.

At least one outer engagement protrusion 936 is formed corresponding to the inner engagement slot 912, extending axially and diametrically outward from the body portion 930 to fit into the inner engagement slot 912.

At least one inner engagement protrusion 938 is formed corresponding to the outer engagement recess 922, extending axially and diametrically inwardly from the body portion 930 to fit into the outer engagement recess 922.

The tolerance ring 900 may be made of spring steel to absorb and accumulate energy using elastic deformation between the rotation shaft 210 and the sensor assembly 500 to provide a cushioning effect.

The tolerance ring 900 in this embodiment is interposed between the rotation shaft 210 and the sensor assembly 500, and is inserted into and engaged with the mounting groove 910 together with the rotational force transmission portion 920 to transmit the rotational force of the rotation shaft 210 to the sensor assembly 500.

Accordingly, this embodiment enables the sensor assembly 500 to stably rotate within a certain angle even in the event of a change in the angle between the sensor assembly 500 and the rotation shaft 210, thereby maintaining a constant gap between the magnet 530 and the motor position sensor.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. Also, it is noted that any one feature of an embodiment of the present disclosure described in the specification may be applied to another embodiment of the present disclosure. Similarly, the present invention encompasses any embodiment that combines features of one embodiment and features of another embodiment. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A hydraulic supply comprising:
a motor coupled to a modulator block and having a stator and a rotor;
a rotation shaft coupled to the rotor to rotate with the rotor; and
a sensor assembly coupled to the rotation shaft to measure rotation frequency of the rotation shaft,
wherein the sensor assembly rotates with the rotation shaft in response to a change in an angle between the rotation shaft and the rotor.

2. The hydraulic supply of claim 1, wherein the rotation shaft comprises:
a mounting groove formed at an end opposite to an end of the rotation shaft to which the rotor is coupled in an axial direction toward the sensor assembly; and
a pair of axially elongated slots formed through the rotation shaft at both diametrical sides from an inside of the mounting groove,
wherein the sensor assembly comprises:
a shaft coupled with the rotation shaft;
a ball member inserted into the mounting groove and integrally formed at one end of the shaft;
a pin member engaged through the ball member such that both side ends are respectively positioned in the slots; and
a magnet mounted at the other end of the shaft.

3. The hydraulic supply of claim 2, wherein the mounting groove includes:
a tapered inclined portion with a diameter decreasing from an outer side toward the inside of the mounting groove so that the ball member is inserted therethrough; and
an accommodation portion formed continuously inwardly from the inclined portion and having a straight structure to accommodate the ball member.

4. The hydraulic supply of claim 2, wherein the slot includes:
a guide portion along which the pin member is movable in the longitude direction; and
an anti-dislodging portion formed with a width smaller than a diameter of the pin member to prevent the pin member from dislodging;

5. A hydraulic supply comprising:
a motor coupled to a modulator block and having a stator and a rotor;
a rotation shaft coupled to the rotor to rotate with the rotor;
a sensor assembly coupled to the rotation shaft to measure rotation frequency of the rotation shaft; and
a tolerance ring interposed between the rotation shaft and the sensor assembly to transmit a rotational force of the rotation shaft to the sensor assembly such that the sensor assembly rotates with the rotation shaft in response to a change in an angle between the sensor assembly and the rotation shaft.

6. The hydraulic supply of claim 5, wherein the rotation shaft comprises:
a mounting groove formed at an end opposite to an end of the rotation shaft to which the rotor is coupled in an axial direction toward the sensor assembly,
wherein the sensor assembly comprises:
a shaft coupled with the rotation shaft;
a rotational force transmission portion which is integrally formed at one end of the shaft and on which the tolerance ring is mounted so that the rotational force transmission portion is inserted into the mounting groove together with the tolerance ring; and
a magnet mounted at the other end of the shaft.

7. The hydraulic supply of claim 6, wherein the mounting groove includes an axially elongated engagement slot formed through the rotation shaft at one or both diametrical sides from the inside of the mounting groove;
wherein the rotational force transmitting portion includes at least one outer support surface formed in a planar shape parallel with a center axis on an outer surface fitted into the tolerance ring;
wherein the tolerance ring supports the outer support surface of the rotational force transmitting portion when the tolerance ring is mounted thereon, and is inserted into and engaged with the mounting groove and the engagement slot to transmit a rotational force of the rotation shaft to the sensor assembly.

8. The hydraulic supply of claim 7, wherein the tolerance ring includes:
a support body inserted into the mounting groove and having an engagement hole axially formed such that the rotational force transmission portion is inserted therethrough and at least one inner support surface formed on an inner surface of the engagement hole in a planar shape parallel with the center axis in correspondence with the outer support surface; and
at least one protrusion formed on an outer surface of the support body in correspondence with the engagement slot.

9. The hydraulic supply of claim 8, wherein the tolerance ring is made of an elastic material having elasticity of returning to its original shape from a deformed state.

10. The hydraulic supply of claim 6, wherein the mounting groove includes at least one inner support recess formed longitudinally in the axial direction on an inner surface,
wherein the rotational force transmission portion includes at least one outer support recess formed longitudinally in the axial direction on an outer surface,
wherein the tolerance ring transmits the rotational force of the rotation shaft to the sensor assembly while being fitted into the inner support recess and the outer support recess.

11. The hydraulic supply of claim 10, wherein the tolerance ring includes:
a support portion supported at one end of the rotational force transmitting portion facing the rotation shaft;
at least one first support protrusion formed corresponding to the inner support recess to extend diametrically and axially from the support portion to fit into the inner support recess; and
at least one second support protrusion formed corresponding to the outer support recess to extend diametrically and axially from the support portion to fit into the outer support recess.

12. The hydraulic supply of claim 11, wherein the support portion is convexly hemispherical, at least in part, in shape toward the rotation shaft and is supported at one end of the shaft such that the sensor assembly rotates with the rotation shaft within a certain angle in response to a change in the angle between the sensor assembly and the rotation shaft.

13. The hydraulic supply of claim 11, wherein the first support protrusion is elastically deformed between the rotation shaft and the sensor assembly and is convexly bent outwardly in a diametrical direction and fits into the inner support recess to transmit the rotational force of the rotation shaft to the sensor assembly.

14. The hydraulic supply of claim 11, wherein the second support protrusion is elastically deformed between the rotation shaft and the sensor assembly and is convexly bent inwardly in a diametrical direction and fits into the outer support recess to transmit the rotational force of the rotation shaft to the sensor assembly.

15. The hydraulic supply of claim 6, wherein the mounting groove includes at least one inner engagement recess formed longitudinally in the axial direction on the inner surface,
wherein the rotational force transmission portion includes at least one outer engagement recess formed longitudinally in the axial direction on the outer surface,
wherein the tolerance ring transmits a rotational force of the rotation shaft to the sensor assembly while being fitted into the at least one inner engagement recess and the at least one outer engagement recess.

16. The hydraulic supply of claim 15, wherein the tolerance ring includes:
a body portion inserted into the mounting groove while surrounding the rotational force transmission portion;
at least one outer engagement protrusion formed corresponding to the at least one inner engagement recess to extend axially and diametrically outwardly from the body portion to fit into the at least one inner engagement recess; and
at least one inner engagement protrusion formed corresponding to the at least one outer engagement recess to extend axially and diametrically inwardly from the body portion to fit into the at least one outer engagement recess.

17. The hydraulic supply of claim 16, wherein the body portion includes an incision continuously formed along an entire length from one axial side to the other such that the diameter varies with elastic deformation.

18. The hydraulic supply of claim 17, wherein the body portion includes at least one resilient part formed at regular circumferential intervals on an outer surface in a convex shape that is deformable by an external force.

19. The hydraulic supply of claim 18, wherein the resilient part is elongated in the axial direction and elastically deforms between the rotation shaft and the sensor assembly to provide a cushioning effect.

20. The hydraulic supply of claim 15, wherein the tolerance ring is made of spring steel to absorb and accumulate energy using elastic deformation between the rotation shaft and the sensor assembly to provide a cushioning effect.
